(19) United States
(12) Patent Application Publication
(10) Pub. No.: US 2004/0232064 A1
(43) Pub. Date: Nov. 25, 2004

(54) Cartridge filters and housing connections therefor

(76) Inventors: James Wilkinson, East Greenbush, NY (US); Thomas J. Rigney, Valatie, NY (US); James E. Johanson, Chatham, NY (US)

Correspondence Address: Thomas J. Durling, DRINKER BIDDLE & REATH LLP, One Logan Square, 18th & Cherry Streets, Philadelphia, PA, 19103-6996, US

(21) Appl. No.: 10/847,725

(22) Filed: May 17, 2004

Related U.S. Application Data
(60) Provisional application No. 60/472,848, filed on May 23, 2003.

(51) Int. Cl. B01D 21/24

(52) U.S. Cl. 210/435; 210/443; 210/299

(57) ABSTRACT

A cartridge filter is provided having a housing body, a sump releasably attached to the housing body, and a filter cartridge within the housing body releasably attached to the housing body by a screw connection. The sump is attached to the housing body by a separate screw connection. The screw connection includes a first screw formation on the sump having a sloped screw surface and, at the leading end, a lug projecting above the sloped screw surface. A second screw formation is also provided on the housing body having a sloped screw surface along which the lug can run. A further projection is positioned on the housing body to engage the leading end of said first screw formation and to deflect the lug so that the first screw formation hooks over the trailing end of the second screw formation, when the connection is fully tightened.

### CROSS-REFERENCE TO RELATED APPLICATION

This application claims the benefit of U.S. Provisional Application No. 60/472,848, filed May 23, 2003.

### FIELD OF THE INVENTION

The present invention relates connections for filter cartridges and the housings that retain filter cartridges.

### BACKGROUND OF THE INVENTION

A radial-flow cartridge filter typically has a housing body fixed to a piece of machinery within which flows a fluid that is to be filtered. The housing body has a central outlet from the filter to the machinery for filtered fluid, and a peripheral inlet from the machinery to the filter for fluid to be filtered. A tubular filter cartridge is placed end-on to the housing body, with its end sealing against the housing body between the inlet and the outlet. A sump (other terms are also used) is then placed over the cartridge, and is sealed and fastened to the housing body outside the inlet. The sump consists essentially of a casing enclosing the filter cartridge, and sealed to the housing body. The space between the sump and the filter cartridge forms an inlet plenum, and the central space of the filter cartridge forms an outlet plenum. Variants on this system are possible, for example, the inlet and outlet may be reversed, and/or one of them may be connected directly to the environment or to an external source or sink of fluid.

In the simplest arrangement, the filter cartridge is merely captive between the housing body and the sump. This results in the filter cartridge remaining in the sump, or falling off, when the sump is removed, and presents difficulty in aligning the filter cartridge correctly with the housing body when the filter cartridge is installed. It has been proposed to mount the filter cartridge on a central core, optionally with a fastening or retainer for the cartridge at the distal end. However, these arrangements increase the cost and complexity of the filter unit, and the difficulty of inserting and removing the filter cartridge. Because the actual filter cartridge is typically disposable, it is important to keep it as simple and inexpensive as possible.

The sump is commonly screw-threaded to the housing body. However, multi-turn screw threads are slow to fasten and release and, because the threads have to be relatively fine, are easily damaged. Multi-start short-turn screw threads, including interrupted screws and bayonet fittings, are quick to fasten and release but, because of their short travel and usually relatively steep thread pitch, are not very secure.

### SUMMARY OF THE INVENTION

In one aspect, the present invention provides a cartridge filter comprising a housing body, a filter cartridge and a sump. The end of the cartridge that engages the sump is secured to the housing body by a screw-threaded connection that is separate from the connection of the sump to the housing.

In another aspect, the present invention provides a screw connection in which one part has at least one first helical thread. The other part has at least one corresponding second helical thread, with a lug at the leading end that runs on the first helical thread as the two parts are being tightened together. The first helical thread has a free inner end, and when the lug reaches the free inner end the two parts can separate slightly axially, so that the lug slips over the free end. A projection on the first part engages the front end of the second thread and deflects it as the lug passes the free end of the first thread, ensuring that the lug slips over the free end. The lug may be gripped between the projection and the free end of the first thread, possibly with a slight snap action.

Once the lug has slipped over the free end of the first thread, it cannot be unscrewed without moving axially to pass back over the free end. This restrains the screw connection from coming unfastened in use, especially if the filter is operating with an appreciable overpressure in the sump, which will hold the two screw threads together. Preferably, however, the end face of the free end of the first thread, and the back face of the lug that engages it, are angled so that a turning force, without any axial lifting component, will cause them to ride over each other and release the connection.

In another aspect, the present invention provides a filter cartridge for use in a cartridge filter having a housing body and a sump releasably attached to the housing body and enclosing the cartridge, the cartridge comprising: an end with screw thread formations for engagement with corresponding screw thread formations on a housing body of said filter.

In another aspect, the present invention provides a housing body for a cartridge filter, comprising a receptacle with screw thread formations for engagement with corresponding screw thread formations in a filter cartridge of said filter and formations for engaging a sump of said filter surrounding said cartridge, independently of said screw connection with said cartridge.

In another aspect, the present invention provides a screw connection comprising a first member and a second member having lugs and screw threads. The lugs and screw threads are so arranged that when the screw connection is engaged each lug engages a screw thread. Each lug has an angled surface and an axially-facing surface. Each screw thread has an angled surface that when the screw connection is engaged aligns with the angled surface of one of the lugs, an axially-facing surface, and an axially extending stop. When the screw connection is fully tightened the lugs rest on the axially-facing surfaces of the screw threads and against the stops.

In another aspect, the present invention provides a cartridge filter comprising a body and a sump removably attachable to the body and arranged to enclose a cartridge. The body is provided with a screw connector arranged to engage a corresponding screw connector on the cartridge so as to retain the cartridge on the body when the sump is removed.

The basic aspects of the present invention may be combined in a number of forms. The preferred aspects of the various constructions may be used in conjunction with one another or used alone. The various features provide certain advantages over the prior art. These advantages will be described herein and will be understood by those skilled in the art upon reviewing the description and drawings.

### BRIEF DESCRIPTION OF THE DRAWINGS

For the purpose of illustrating the invention, there are shown in the drawings forms of the invention which are presently preferred; it being understood, however, that this invention is not limited to the precise arrangements and instrumentalities shown.

FIG. 1 is a perspective view of an embodiment of a cartridge filter according to the present invention.

FIG. 2 is an axial section through the cartridge filter of FIG. 1 as taken along the line 2-2 in FIG. 1.

FIG. 3 is a perspective view of the proximal end of a sump and a socket for the sump in a housing body of the cartridge filter of FIG. 1.

FIG. 4 is a perspective view of the proximal end of a filter cartridge and a converter for the cartridge in the filter of FIG. 1.

FIG. 5A is a cross section along the line 5A-5A in FIG. 2, showing the filter body and sump assembled and locked together.

FIG. 5B is a view similar to FIG. 5A, showing the sump in an unlocked orientation.

FIG. 6A is a cross section along the line 6A-6A in FIG. 2, partly broken away, showing the cartridge and converter assembled and locked together.

FIG. 6B is a view similar to FIG. 6A, showing the cartridge in an unlocked orientation.

FIGS. 7A through 7D show a sequence of the engagement of the sump and socket of FIG. 3.

FIGS. 8A through 8D show a sequence of the engagement of the cartridge and converter of FIGS. 6 and 7.

### DETAILED DESCRIPTION OF THE DRAWINGS

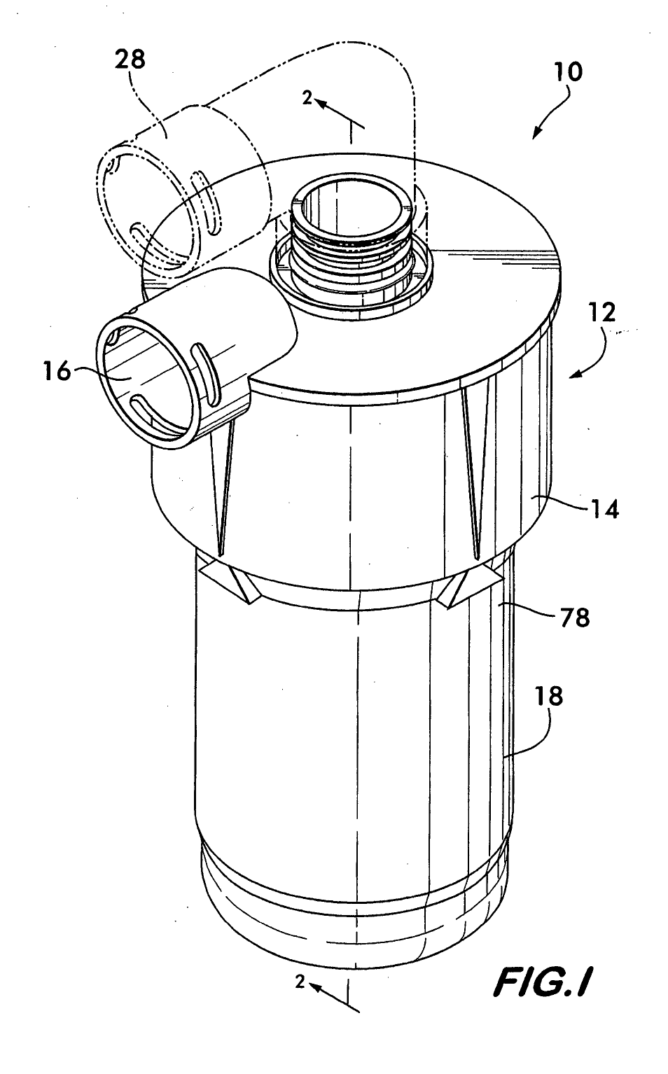

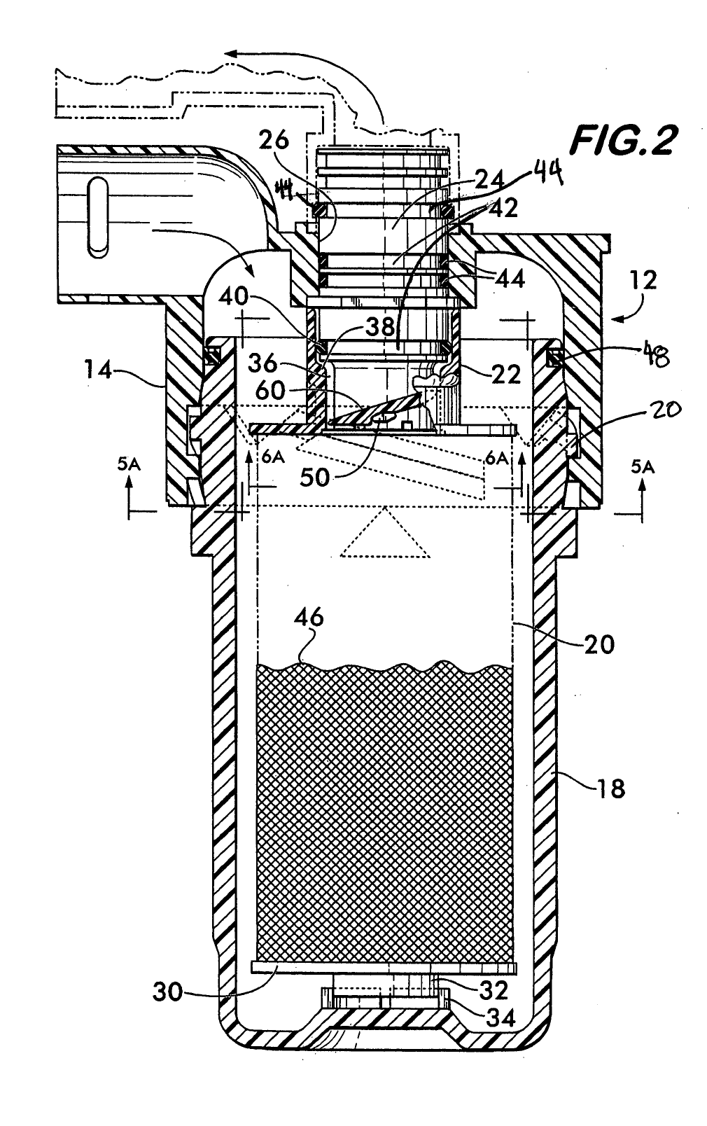

Referring to the drawings, wherein like reference numerals identify similar elements in the various Figures, there is shown, initially in FIGS. 1 and 2, one embodiment of cartridge filter according to the present invention, indicated generally by the reference numeral 10. The cartridge filter 10 comprises a housing body 12, having a head 14 that receives the proximal end of a sump 18 that encloses a filter cartridge 20. The head 14 has a fluid inlet 16 at one side. A tubular proximal end 22 of the filter cartridge 20 is connected to an adapter 24 mounted in an opening 26 in the top of the head 14 of the housing body 12. The adapter 24 is connected to an outlet 28 for filtered fluid. As shown in FIG. 2, the proximal end of the sump 18 and the cartridge 20 are the upper ends, and the distal ends are the lower ends. However, the cartridge filter may be positioned in other orientations.

Preferably, the distal end 30 of the filter cartridge 20 is closed, and when the filter is assembled the inside of the sump 18 does not contact the filter cartridge. The cartridge 20 may have a projecting collar 30 which mates loosely in a corresponding collar 32 on the inside of the sump 18 to steady the cartridge against transverse forces. Alternatively, the filter cartridge 20 may have an open distal end, which is closed in use by a seal on the inside of the distal end of the sump 18. Alternatively, the distal end of the sump 18 may press on the distal end of the cartridge 20. However, it is preferred that the net force on the cartridge 10, from all sources other than the connection between the cartridge end 12 and the adapter 24, be in the outward direction, towards the distal end.

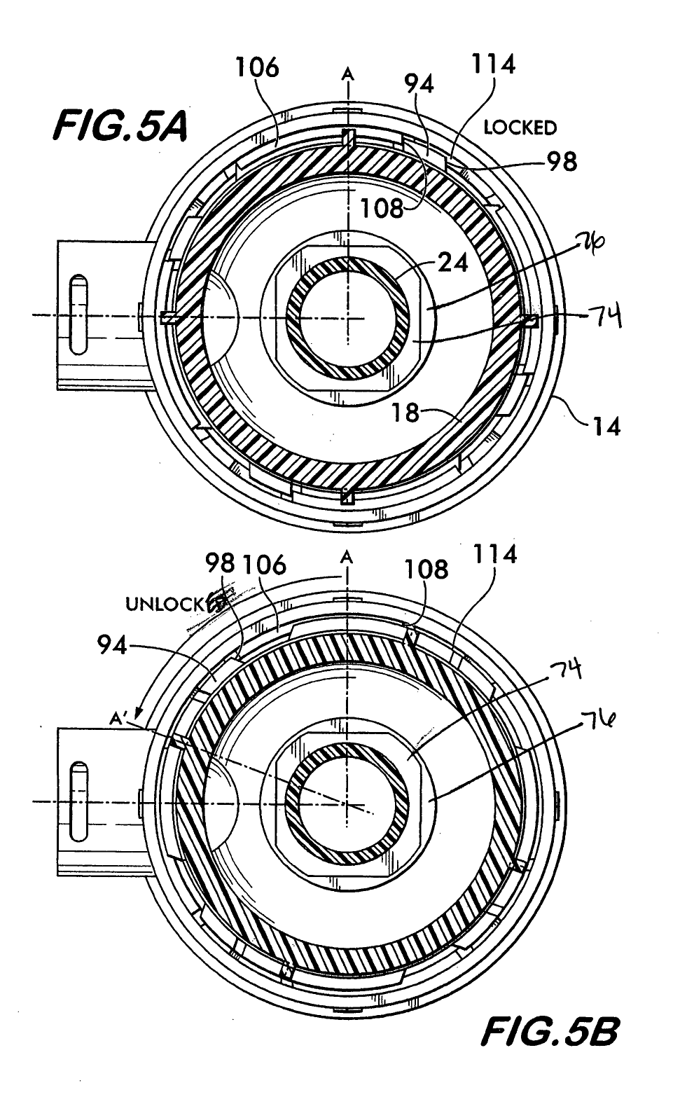

Referring now to FIGS. 2 and 5, the proximal end 22 of the cartridge defines within it an axial passage 36 for the flow of fluid out of the filter. As is best shown in FIG. 2, the proximal end 22 may be provided with a seat 38 for an O-ring 40 in a groove 42 on the adapter 24. The adapter 24 is provided with further grooves 42 for O-rings 44 to seal against the wall of the opening 26 in the head 14 of the housing body 12 and against the outlet 28. The axial passage 36 is thus sealed both from the space outside the filter medium 46 of the cartridge, which space is occupied by unfiltered fluid, and from the exterior. The end of the cartridge 20 is provided on its outside with a protrusion 32 that forms the male connection between the cartridge 20 and the botton receptacle 34 on the sump 18. An O-ring 48 seals the sump 18 to the head 14.

Referring now especially to FIGS. 2, 4, 6 and 8, a plurality of protrusions 50, preferably two, are provided evenly spaced around the adapter 24. Each protrusion 50 is generally parallelogram shaped, with two faces 52 and 54 facing axially, one towards the distal end, towards the sump 18, and one towards the proximal end, towards the outlet 28. The other two faces 56 and 58 are aligned generally in the line of a screw thread. A thread face 56 faces towards the proximal end, and a back face 30 faces towards the distal end and clockwise as seen from the distal end. The corners of the protrusion 50 are rounded.

A plurality of threads 60 equal in number to the protrusions 50 are formed on the inside of the tubular end 22 of the cartridge 20. Each thread 60 has a main thread surface 62, facing towards the distal end, that engages the thread face 56 of one of the protrusions 50. At the distal end of the main thread surface 62, which is the trailing end as the connection is being tightened, is a level surface 64 that, when the screw connection is fully tightened, receives the proximal face 26 of the protrusion 50. The level surface 64 is followed by an axial face 66 that acts as an end stop. On the proximal side of the thread 60 is a counter-face 68 that is generally parallel to the main thread surface 38. The arcuate length of the thread surface 62 and level surface 64, from the beginning 70 of the thread 60 to the axial face 66, is approximately ⅓ of the circumference of the tubular end 22 where there are two threads 60.

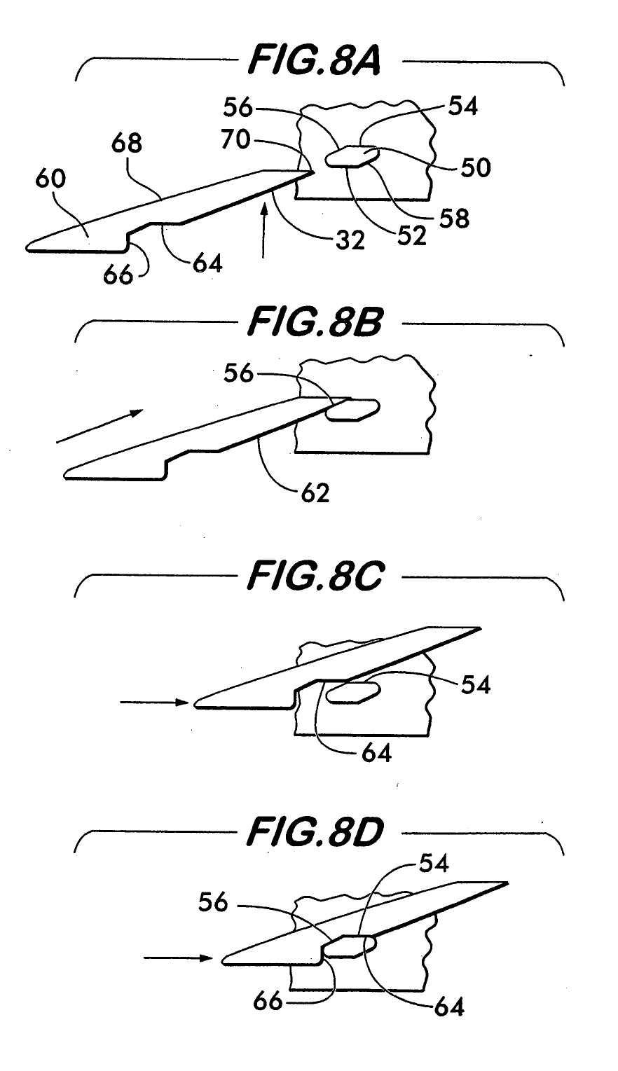

In use, the proximal end 22 of the cartridge 20 is inserted into the head 14 of the filter head 12 and over the end of the adapter 24 from the distal end until the protrusions 50 pass the beginnings 70 of the threads 60. The cartridge is then rotated, clockwise as seen from the distal end, until the thread faces 56 of the protrusions 50 contact the thread surfaces 62 of the threads 60. As the cartridge 20 is rotated further, the thread surfaces 62 slide along the protrusions 50 as shown by the arrow in FIG. 8B, tightening the cartridge 20 towards the proximal end of the filter body head 14. After approximately ⅓ of a turn, the protrusions 50 pass onto the level surfaces 64 as shown by the arrow in FIG. 8C. Once the protrusions are fully onto the level surfaces 64, the protrusions abut the end stops 66, preventing further movement as shown by the arrow in FIG. 8D.

The level surfaces 64 and the axial end stops 66 ensure that the cartridge 20 is maintained in a fixed position. Because the protrusions 50 are resting on level surfaces 64, and not on the thread surfaces 62, there is no tendency for the cartridge 20 to unscrew itself in use. The contact force between the axial faces 54 and the level surfaces 64 generates a frictional force that holds the cartridge 20 in place.

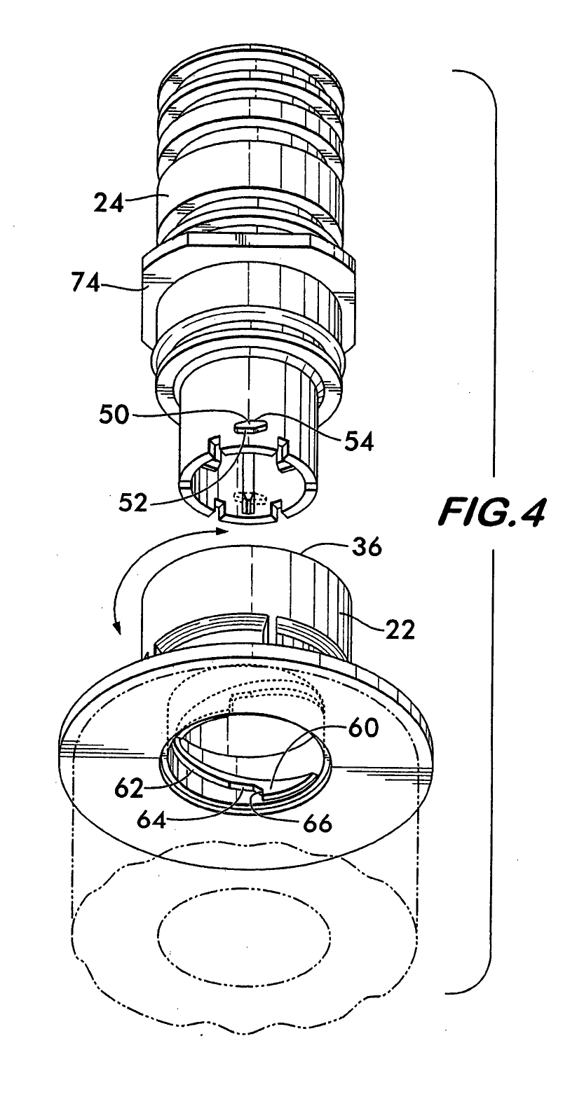

As is best seen from FIGS. 4 and 5, flange 74 has a partially square shape, with flats, and is seated in a correspondingly shaped socket 76 in the head 14. The engagement between the flats of the flange 74 and the socket 76 prevents the adapter 24 from rotating while the cartridge 20 is being screwed in or unscrewed.

Because the cartridge 20 is secured to the body 12 by the screw connection shown in FIG. 2, it can be positioned, and will remain in position, without requiring any other components. On disassembly, it remains in position when the sump 18 enclosing it is removed, greatly simplifying disassembly.

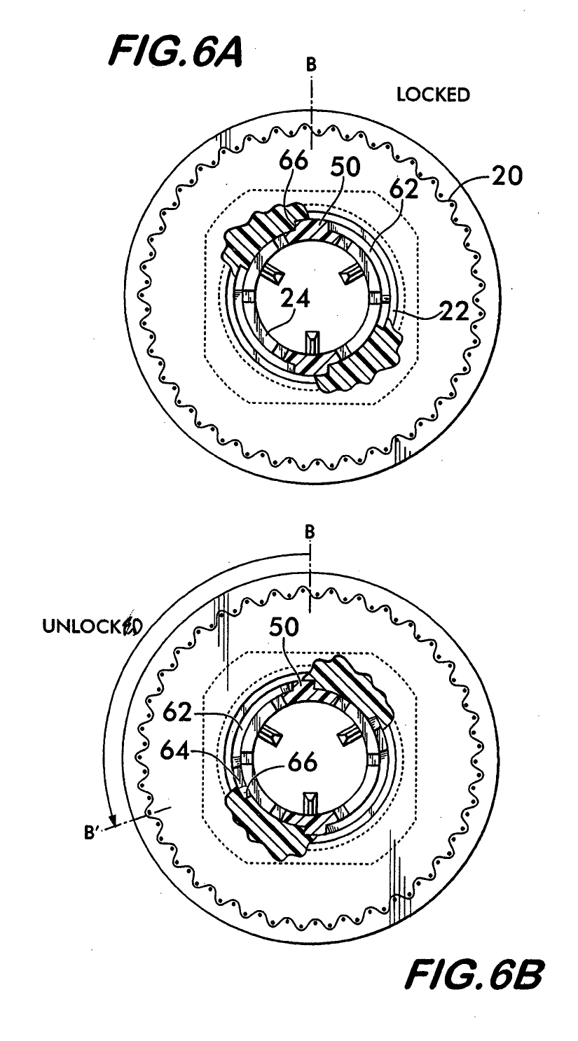

To remove the cartridge 20, once the sump 18 has been removed, the cartridge is simply rotated in the opposite direction, which is the direction of the arrow in FIG. 6B. The protrusions 50 move off the level surfaces 64 and down the thread surfaces 62. Once released, the cartridge may turn without moving further axially. However, in that event the back face 58 of each protrusion 50 will contact the back surface 68 of the next thread 60, and the two will co-operate to produce a positive unscrewing action, expelling the cartridge 20 axially from the head 14.

As may be seen from FIG. 2, the cartridge 20 includes threads 60. The cartridge 20 can thus be produced at a cost that is only slightly more than that of a corresponding conventional cartridge 20, but is robust and reliable in use.

The assembly and disassembly process requires from the installer only a simple rotation of no more than ⅓ turn, as shown by the arrows in FIGS. 4 and 6, at a torque level that can easily be applied by hand, without using any tools. As is best seen in FIGS. 6A and 6B, one of the protrusions 50, which is used as a reference point, is rotated between the position marked B in the locked position and the position marked B′ in the unlocked position.

Referring now especially to FIGS. 2, 3 and 5, the sump 18 has a body 78 that fits over the filter cartridge 20, and a proximal end 80 that fits into the head 14 of the housing body 12. On the outside of the proximal end 80 is a groove containing the O-ring 48, which seals against a cylindrical surface 82 within the head 14.

The proximal end 80 of the sump 20 is provided with a plurality of short screw threads 84, preferably 3 or 4 in number. Each screw thread 84 has a main thread portion 86, which is essentially a portion of a helical rib. The main thread portion 86 has a thread surface 88 on the distal side, and a back surface 90 on the proximal side. On the distal side of the proximal end of the main thread portion 86, which is the leading end as it is screwed into the head 14, there is a lug 92. The lug 92 has a running surface 94 that is parallel to the main thread portion 86 but projects distally beyond the thread surface 88 and a trailing end surface 96 that faces towards the thread surface 88. The lug 92 is bounded by a leading end surface 98 of the thread 84.

As will be explained below, the trailing end surface 96 of the lug 92 is angled to face partly towards the distal end of the sump 18, and the leading end surface 98 is angled to face partly towards the proximal end of the sump. Each of those end surfaces 96 and 98 forms an angle with the axial direction that is greater than the slip angle between the materials of the sump 18 and the head 14. The leading end surface 98 forms slightly the greater angle with the axial direction.

To the distal side of the middle of each thread 84 is a triangular protrusion 100, bounded by a hypotenuse facing the distal end and two symmetrical sides facing obliquely towards the proximal end.

Screw threads 102, equal in number to the screw threads 84, are provided in the form of ribs on the inside of the housing head 14. Each screw thread 102 has a thread surface 104 facing towards the proximal end of the head 14, and a back surface 106 facing towards the distal end of the outer sleeve. The more proximal end 108 of the screw thread 88, which is the trailing end as the sump 18 is screwed into the sleeve 14, is angled at the same angle as the trailing end 96 of the lug 92.

In the proximal direction from the screw threads 102 is a circumferential shoulder 110, from which triangular salients 112 project. Each salient 112 has a side 114 that faces the trailing end 108 of a respective screw thread 102. The sides 114 are at the same angle to the axial direction as the leading end faces 98 of the screw threads 84 of the sump 18. The space between the trailing end 108 and the side 114 is substantially equal to the length of a lug 92, as will be explained in more detail below.

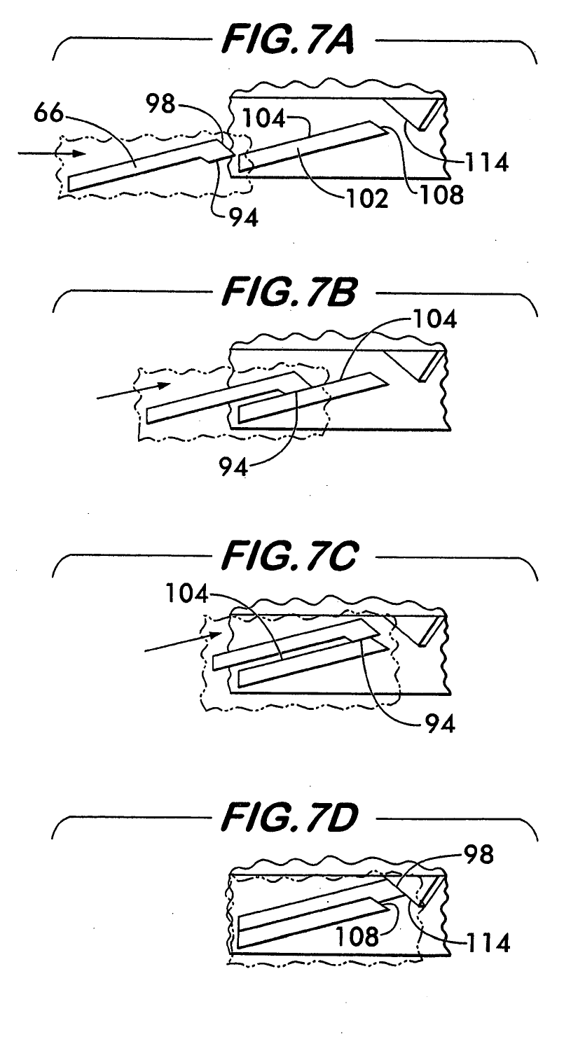

Referring now also to FIG. 7, to attach the sump 18 to the housing head 14, the end 80 of the sump is inserted into the head 14 and rotated, as shown by the arrow in FIG. 7A, so that the running surface 94 of the lug 92 of each thread 84 on the sump 18 engages the thread surface 104 of a thread 102 in the head 14. If the sump 18 is inserted unnecessarily far, the back surface 90 of each thread 84 will contact, and be guided by, the back surface 106 of the next thread 102 or the tip 116 of the salient 112 in between. If the leading end 98 of the screw thread 84 on the sump 18 contacts the side 114 of the salient 112, the screw thread 84 will be deflected outwards, in the distal direction, to pass the tip 116 of the salient and engage its intended thread 102 on the head 14.

Preferably, the tips 116 of the salients 112 are positioned so that, when the running surfaces 94 of the lugs 92 of the threads 84 are running on the thread surfaces 104 of the threads 88, the back surfaces 90 of the threads 84 clear the tips of the salients with no more clearance than is necessary to ensure free running of the screw threads. Preferably also, the cylindrical surface 82 within the head 14 is sufficiently long, and the O-ring 48 is so positioned, that a seal is formed between them as soon as the lug 92 is running on the thread surface 104.

Once the running surfaces of the lugs 92 are on the thread surfaces 104 of the threads 102, the sump 18 is tightened by rotating it, so that the lugs 92 slide up the thread surfaces 104 towards the trailing ends 108, as shown by the arrows in FIGS. 7B and 7C. The leading end 98 of the sump thread 84 contacts the side 114 of the salient 112 just as the trailing end 96 of the lug 92 reaches the trailing end 108 of the thread 102. The slope of the side 114 of the salient deflects the thread 84 outwards, so that the lug 92 enters the gap between the trailing end 108 and the side 114. Preferably, the thread 84 just contacts, or just fails to contact, the shoulder 110 when it contacts the salient side 114.

Because of the slight difference in angles between the surfaces 98 and 114 and the surfaces 96 and 108, the lug 92 is a closer fit in the gap when it first enters it than when it is fully into the gap with the thread surface 88 resting on the thread surface 104. By precise dimensioning a slight snap action may be produced, ensuring that the lug is retained in the gap.

In this position, the sump 18 is supported on the head 14 by contact along the full length of the thread surfaces 88 and 104. The sump is retained in position by the snap action of the lugs 92 in the gaps, and in use by the pressure of the fluid to be filtered in the sump. Where the fluid is a liquid, the distal end of the sump 18 is preferably downwards, and the weight of the liquid in the sump then holds the sump in place on the threads 102. A spring may be provided to hold the sump 18 in engagement with the threads 102, but that is believed in general to be unnecessary.

The sump 18 can be removed only if it moves axially inwards, towards the proximal end, so that the trailing end 96 of the lug 92 moves up the trailing end 108 of the thread 102 and the lug moves onto the thread surface 104. Because of the slope of the faces 96 and 108, this can be achieved by rotating the sump 18 in the unscrewing direction, which is the direction of the arrow in FIG. 5B. Removing the sump is thus extremely simple. However, a sufficiently firm rotation is needed to overcome the initial resistance of the slope 108 that there is very little risk of the sump's becoming unscrewed inadvertently.

The sump 18 can thus be removed and installed with a simple rotary motion, without requiring tools, while not requiring any additional components or moving parts to lock the sump into place. Because it does not require the extra force of tools to remove or install, it does not need to withstand either the high torques applied by such tools or the crushing forces that such tools can apply in order to get a firm grip on a round sump in order to deliver such high torques.

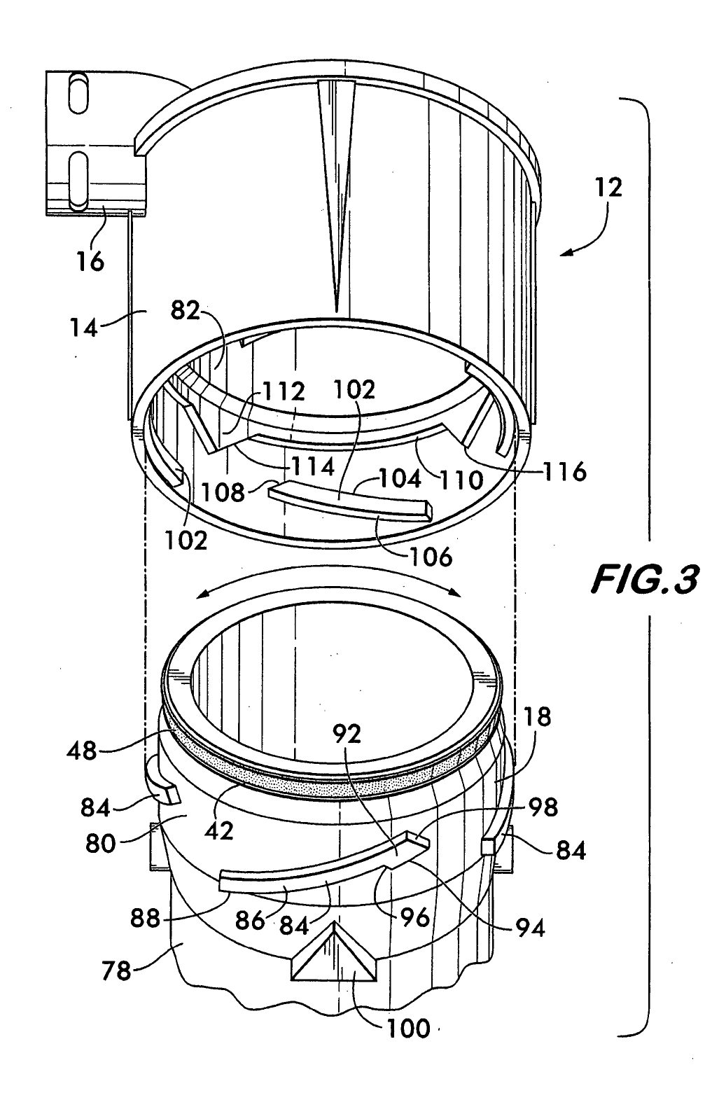

The assembly and disassembly process requires from the installer only a simple rotation of less than ¼ turn, as shown by the arrows in FIGS. 3 and 5, at a torque level that can easily be applied by hand, without using any tools. As is best seen in FIGS. 5A and 5B, the tip of one of the triangular protrusions 100, which is used as a reference point, is rotated between the position marked A in the locked position and the position marked A′ in the unlocked position.

Although the connections of the cartridge 20 and the sump 18 to the housing head 14 have been described separately, those skilled in the art will understand how features from the two may be combined or varied. For example, seals other than or additional to the O-rings 40 and 48 and the seat 38 and the cylindrical sealing surface 82 may be applied to the sump 18 and/or to the cartridge 20. If O-rings are used, the O-ring may be on either half of each seal. However, it is usually preferred to apply the simpler half of each connection to the cartridge 20, which may be disposable and should therefore be inexpensive.

In the embodiment shown in the drawings, the adapter 24 fits inside the tubular end 22 of the cartridge 20, and the outlet from the cartridge is axially through the adapter to the outlet 28. Alternatively, the tubular end 22 of the cartridge could fit within a socket in the housing head 14, with the protrusions 50 and threads 60 on the outside of the tubular end 22 and the inside of the socket.

Although conventional right-handed screw connections have been illustrated, either or both screw connections may be left-handed. Using screw connections of opposite hands may reduce the risk of the cartridge 20 being inadvertently unscrewed as the sump 18 is removed, especially if the two are in contact at the distal end. Using one or both left-handed screw connections may serve to hinder dismantling of the filter by untrained personnel.

The filter has been described herein using a cylindrical inward-flow filter. Those skilled in the art will understand that the invention may be used with other forms of filter. Also, if the filter is an air intake or exhaust filter, one side of the filter unit may be connected directly to the atmosphere.

Although the invention has been described with reference to a single cartridge filter using the screw connections of the invention for both the cartridge and the sump, either screw connection may be used without the other. Further, the connections have been shown with two starts for the threading on the cartridge and socket, and four starts for the threading on the sump and sleeve. It should be understood that those numbers may vary. For a stable connection, at least two starts are considered desirable, while excessive numbers may result in undesirably thin and/or steep threads.

The screw connections have been shown as formed largely by projections from the walls of the connected components. Although this structure is preferred, the connections can instead be formed using the edges of recesses for some of the operative surfaces.

The invention herein has been described and illustrated with respect to certain exemplary embodiments. It should be understood by those skilled in the art that the foregoing and various other changes, omissions and additions may be made therein and thereto, without departing from the spirit and scope of the present invention.

1. A cartridge filter comprising:
a housing body;
a sump releasably attached to the housing body; and
a filter cartridge within the housing body releasably attached to the housing body by a screw connection that is separate from the connection of the sump to the housing.

2. A cartridge filter according to claim 1, wherein said screw connection comprises screw thread formations on said filter cartridge and on said housing body.

3. A cartridge filter according to claim 2, wherein said screw thread formations comprise a plurality of screw thread formations evenly spaced about a circumference of each of said filter cartridge and said housing body.

4. A cartridge filter according to claim 3, wherein said circumference is a circumference of a tubular formation providing communication for fluid flow between said housing body and an interior space of said filter cartridge.

5. A cartridge filter according to claim 3, wherein said screw formations define sloped surfaces that slide over each other when the connection is being screwed up or unscrewed, and axially-facing surfaces that rest on each other when the connection is in a fully-engaged condition.

6. A cartridge filter according to claim 5, wherein said screw thread formations on one of said filter cartridge and said housing body comprise projections having a said sloped surface and a said axially-facing surface of comparable length.

7. A cartridge filter according to claim 6, wherein said screw thread formations that comprise projections are largely bounded by two opposite sloped surfaces and two opposite axially-facing surfaces of comparable length.

8. A cartridge filter according to claim 3, wherein said screw thread formations on at least one of said filter cartridge and said housing body comprise axially-extending surfaces against which said screw thread formations on the other of said filter cartridge and said housing body stop when the connection is fully engaged.

9. A cartridge filter according to claim 2, wherein said housing body comprises an adapter for said cartridge, and said screw thread formations on said housing body are on said adapter.

10. A cartridge filter according to claim 1, wherein said connection between said sump and said housing body comprises a screw connection.

11. A cartridge filter according to claim 10, wherein said screw connection between said sump and said housing body comprises:
on one of said sump and said housing body, a first screw formation having a sloped screw surface and, at the end that is leading with respect to tightening of the connection, a lug projecting above said sloped screw surface;
on the other of said sump and said housing body, a second screw formation having a sloped screw surface along which said lug can run as said screw connection is being tightened and an end at the end that is trailing with respect to tightening of the connection; and
on the other of said sump and said housing body, a feature positioned to engage the leading end of said first screw formation and to deflect said lug over the trailing end of said second screw formation.

12. A cartridge filter according to claim 11, wherein said lug is secured between said feature and said second screw formation.

13. A cartridge filter according to claim 11, wherein said lug has a running surface parallel to said sloped screw surface of said first screw formation.

14. A cartridge filter according to claim 11, wherein said lug has a sloped trailing end and said trailing end of said second screw formation is correspondingly sloped at an angle such that when said lug is over said trailing end a rotational force in the unscrewing sense can cause said sloped ends to slide over one another, lifting said lug onto said sloped screw surface of said second screw formation.

15. A cartridge filter according to claim 11, comprising equal pluralities of said first screw formations, said second screw formations, and said features.

16. A cartridge filter according to claim 15, wherein each said feature is so positioned that, when said lugs are resting on the leading ends of said sloped screw surfaces of said second screw formations, said projections form a running clearance with back surfaces of said first screw formations.

17. A filter cartridge for use in a cartridge filter having a housing body and a sump releasably attached to the housing body and enclosing the cartridge, the cartridge comprising: an end with screw thread formations for engagement with corresponding screw thread formations on a housing body of said filter.

18. A filter cartridge according to claim 17, wherein said screw thread formations comprise a plurality of screw thread formations evenly spaced about a circumference of said filter cartridge.

19. A filter cartridge according to claim 17, wherein said screw thread formations define sloped surfaces that are arranged to slide over correspondingly sloped surfaces of said housing body when the connection is being screwed up or unscrewed, and axially-facing surfaces that are arranged to rest on corresponding axially-facing surfaces of said housing body when the connection is in a fully-engaged condition.

20. A housing body for a cartridge filter, comprising:
a receptacle with screw thread formations for engagement with corresponding screw thread formations in a filter cartridge of said filter; and
formations for engaging a sump of said filter surrounding said cartridge, independently of said screw connection with said cartridge.

21. A housing body according to claim 20, wherein said screw thread formations comprise a plurality of screw thread formations evenly spaced about a circumference of each of said housing body and said cartridge.

22. A housing body according to claim 21, wherein said circumference of said housing body is a circumference of a tubular formation providing communication for fluid flow between said housing body and an interior space of said filter cartridge.

23. A housing body according to claim 20, wherein said screw formations define sloped surfaces over which correspondingly sloped surfaces on said cartridge are arranged to slide when the connection is being screwed up or unscrewed, and axially-facing surfaces on which corresponding axially-facing surfaces of said cartridge are arranged to rest when the connection is in a fully-engaged condition.

24. A housing body according to claim 23, wherein said screw thread formations comprise axially-extending surfaces against which corresponding screw thread formations on said filter cartridge are arranged to stop when the connection is fully engaged.

25. A screw connection comprising:
a first component having a first screw formation with a bearing surface and, at the end that is leading with respect to tightening of the connection, a lug projecting from said sloped screw surface; and
a second component having:
a second screw formation with a sloped screw surface along which said lug can run as said screw connection is being tightened and an end at the end that is trailing with respect to tightening of the connection; and
a projection positioned to engage the leading end of said first screw formation and to deflect said lug over the trailing end of said second screw formation.

26. A screw connection according to claim 25, wherein said lug is secured between said projection and said second screw formation.

27. A screw connection according to claim 25, wherein said lug has a running surface that, when the screw connection is being screwed up, is parallel to and runs on the sloped screw surface of said first screw formation.

28. A screw connection according to claim 25, wherein said lug has a sloped trailing end and said trailing end of said second screw formation is correspondingly sloped at an angle such that when said lug is over said trailing end a rotational force in the unscrewing sense can cause said sloped ends to slide over one another, lifting said lug onto said sloped screw surface of said second screw formation.

29. A screw connection according to claim 25, comprising equal pluralities of said first screw formations, second screw formations, and projections.

30. A screw connection according to claim 29, wherein each said projection is so positioned that, when said lugs are resting on the leading ends of said sloped screw surfaces of said second screw formations, said projections form a running clearance with back surfaces of said first screw formations.

31. A screw connection comprising a first member and a second member having lugs and screw threads so arranged that when the screw connection is engaged each lug engages a screw thread, wherein each lug has an angled surface and an axially-facing surface, and each screw thread has an angled surface that when the screw connection is engaged aligns with the angled surface of one of the lugs, an axially-facing surface, and an axially extending stop, and wherein when the screw connection is fully tightened the lugs rest on the axially-facing surfaces of the screw threads and against the stops.

32. A cartridge filter comprising:
a body; and
a sump removably attachable to the body and arranged to enclose a cartridge;
wherein the body is provided with a screw connector arranged to engage a corresponding screw connector on the cartridge so as to retain the cartridge on the body when the sump is removed.

33. A cartridge filter according to claim 32, wherein the body is provided with an adapter for the cartridge and the screw connector is on the adapter.

34. A cartridge filter according to claim 32, wherein the sump and the body are provided with screw connectors for attaching the sump to the body.
